(19) United States
(12) Patent Application Publication
(10) Pub. No.: US 2025/0117523 A1
(43) Pub. Date: Apr. 10, 2025

(54) SYSTEMS AND METHODS FOR SOFT FUSE OVERRIDE

(71) Applicants: ATI Technologies ULC, Markham (CA); Advanced Micro Devices, Inc., Santa Clara, CA (US)

(72) Inventors: Valeri Kirischian, Markham (CA); Steven Leonard Roberts, Austin, TX (US); Ruchir Badola, Austin, TX (US)

(73) Assignees: ATI Technologies ULC, Markham (CA); Advanced Micro Devices, Inc., Santa Clara, CA (US)

(21) Appl. No.: 18/911,080

(22) Filed: Oct. 9, 2024

Related U.S. Application Data
(60) Provisional application No. 63/589,016, filed on Oct. 9, 2023.

(51) Int. Cl. G06F 21/70

(52) U.S. Cl. CPC G06F 21/70

(57) ABSTRACT

A method can include overriding settings of an integrated circuit device by reading one or more settings from a setting record that correspond to a part number of the integrated circuit device. The method can also include performing an override of the settings of the integrated circuit device based on the one or more settings of the setting record that correspond to the part number of the integrated circuit device. Various other methods and systems are also disclosed.

### CROSS REFERENCE TO RELATED APPLICATION

This application claims the benefit of U.S. Provisional Application No. 63/589,016, filed Oct. 9, 2023, the disclosure of which is incorporated, in its entirety, by this reference.

### BACKGROUND

When a computer system starts up, a chip can include burned-in settings for each of the components that are starting up, including a burned-in register value, in coded fuses. Example component settings include, without limitation, power, graphics, clocks, voltage levels, etc. The fuses are read by various components when the components are booting up. A customer does not typically have authorization to set the fuse values after a system is delivered.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram illustrating an example system configured to perform soft fuse override, according to one or more implementations of the present disclosure.

FIG. 2 is a flow diagram of an example method for performing soft fuse override, according to one or more implementations of the present disclosure.

FIG. 3 is a block diagram of an example device for performing soft fuse override functions, according to one or more implementations of the present disclosure.

FIG. 4 is a block diagram of an example system for soft fuse override, according to one or more implementations of the present disclosure.

FIG. 5 is a block diagram of an additional example system for soft fuse override, according to one or more additional implementations of the present disclosure.

FIG. 6 is a flow diagram of an example method for soft fuse override, according to one or more implementations of the present disclosure.

FIG. 7 is a flow diagram of an example method for soft fuse override, according to one or more additional implementations of the present disclosure.

FIG. 8 is a block diagram of an example device package having an interposer die.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

During initial startup (e.g., prior to delivery to customers), component settings can be adjusted. Adjusting the settings can involve connecting a software tool interface through a Joint Test Action Group (JTAG) standard, and before the chip comes up, programming the settings. Once the settings are programmed, the boot is resumed. Other methods of programming settings include a firmware override of the fuse values.

The present disclosure is generally directed to overriding settings of a microprocessor device. In some examples, a processor starts booting with full initial settings. The processor accesses fuse memory, and the processor can modify the settings and then reset the whole system to include pre-tuned settings, such as settings that are adjusted based on general performance evaluations. Prior to shipping systems to customers, the processor can include the pre-tuned settings and allow deployment of hundreds of systems with standard settings that can be customized to a particular use and application.

If a system is to be provided to a particular customer with certain setting requirements, there can be a specific component for which one or more settings are desired to be tuned. Per-component tuning can occur after systems are received from a fabrication facility (e.g., without requiring sending the system or design back to the fabrication facility to apply new fuse values). A fuse file (e.g., list of settings) can contain every part-specific setting value. Systems according to the present disclosure can search through a list of part serial numbers. If a serial number is found, the system can apply appropriate settings. In this way, parts can be shipped early (e.g., earlier than if systems are tested by customers and later re-tuned to parts and particular needs). In addition, those parts can be deployed with improved performance.

Example implementations set forth herein can perform soft fuse override of one or more microprocessors of one or more systems on chip (SoCs.) For example, the disclosed systems and methods can be implemented with security processors (e.g., root of trust (ROT) microprocessors) coupled to interconnect devices (e.g., active interposer dies (AIDs)) within a socket of a printed circuit board (PCB).

Systems on chip (SoCs) can refer to a type of integrated circuit (IC) design that combines many or all high-level function elements of an electronic device onto a single chip instead of using separate components mounted to a printed circuit board (PCB), such as a motherboard. In an SoC, a central processing unit (CPU) can be fully integrated with memory, graphics processing units (GPUs), and more on a single chip.

A printed circuit board (PCB) can be a medium used in electrical and electronic engineering to connect electronic components to one another in a controlled manner. For example a PCB can take the form of a laminated sandwich structure of conductive and insulating layers, with each of the conductive layers being designed with an artwork pattern of traces, planes, and other features (e.g., like wires on a flat surface) etched from one or more sheet layers of copper laminated onto and/or between sheet layers of a non-conductive substrate. Electrical components can be fixed to conductive pads on the outer layers in the shape designed to accept the component's terminals, generally by means of soldering, to both electrically connect and mechanically fasten them to it. Another manufacturing process can add vias, such as plated-through holes that allow interconnections between layers. PCBs can be single-sided (e.g., one copper layer), double-sided (e.g., two copper layers on both sides of one substrate layer), or multi-layer (e.g., outer and inner layers of copper, alternating with layers of substrate). Multi-layer PCBs allow for much higher component density because circuit traces on the inner layers would otherwise take up surface space between components. SoCs and/or circuit dies can be mounted in one or more sockets of a PCB, and some sockets can accommodate mounting of multiple SoCs and/or circuit dies.

A socket can be an electrical component of a land grid array (LGA) package or pin grid array (PGA) package that provides compressive electrical interconnect between a PCB and a processor. For example, an LGA socket can offer a more durable CPU as the contact pins are on the motherboard socket. In contrast, a PGA socket can offer a more durable motherboard as the pins are on the processor. However, LGA pins are smaller than PGA pins and hence, the LGA socket can offer more space efficiency.

Implementation of an SoC within a socket can benefit from performance of soft fuse override by a security processor in an AID of the SoC. A security processor can also be referred to as a root of trust (ROT). A root of trust can correspond to a logic block that resides in a silicon die that maintains a trust. For example, and without limitation, a root of trust can maintain a trust using one or more encryption schemes, digital signatures, and/or secret keys. In use, a root of trust (ROT) can be implemented as a source that can always be trusted within a cryptographic system. Because cryptographic security is dependent on keys to encrypt and decrypt data and perform functions such as generating digital signatures and verifying signatures, ROT schemes generally include a hardened hardware module. In this context, a hardware root of trust can be the foundation on which all secure operations of a computing system depend. It can contain the keys used for cryptographic functions and enable a secure boot process. It is inherently trusted, and therefore must be secure by design. The most secure implementation of a root of trust is in hardware making it immune from malware attacks. As such, it can be a stand-alone security module or implemented as a security module within a processor or system on chip (SoC).

Reset can include loading a trusted operating system (TOS) on an active interposer die (AID). A driver can be responsible for loading of the TOS. However, the driver only communicates with a platform security processor (PSP) boot loader on a first AID of every socket. The disclosed systems and methods can perform soft fuse override coordinated by each security processor of each AID.

The term “fuse,” as used herein, can generally refer to a fuse element. For example, and without limitation, a fuse can be a wire or strip of fusible metal that melts (e.g., blows) and interrupts a circuit when a current exceeds a particular amperage. In this context, circuit die can have selectively blowable fuses that can be optically read to perform die identification. The present disclosure relates to placing fuses that identify a circuit die on one or more other circuit die in a same stack (e.g., 3D stack) as the circuit die.

The term “soft fuse,” as used herein, can generally refer to any mechanism capable of permanently recording a discoverable status. For example, and without limitation, a soft fuse can correspond to an electronic fuse (eFuse) and/or write once read many (WORM) memory integral to the semiconductor device. In this context, an eFuse can be a dedicated electronic circuit and a WORM can be a programmable read only memory (ROM), a serial peripheral interface (SPI) ROM (e.g., flash memory), etc. The electronic fuse can be integral to the semiconductor device, for example, by being included in the semiconductor device (e.g., transistor layer) and/or in a package of the semiconductor device. In this context, burning an electronic fuse can correspond to activating (e.g., tripping, triggering, toggling, shorting, opening, actuating, flipping, flopping, etc.) an eFuse and/or setting one or more bits and/or memory cells in a WORM memory.

In various aspects, soft fuse override can be performed using the cool reset and secure features of a microprocessor to create a run state that is equivalent to immutable fuses. In some implementations, values read from hard fuses can be overridden in a rewritable memory of a secure microprocessor that determines the run state of the microprocessor, and this override can occur each time the microprocessor is initialized. In other implementations, values read from hard fuses can be overridden in a programmable read only memory, and this override can be performed only once (e.g., a first time the microprocessor is initialized). In such implementations, a setting can be enabled to prevent subsequent execution of some or all of the override process. Such implementations allow per part soft fuse override while reducing or avoiding delay in subsequent system startups that would otherwise arise from searching through override settings for numerous parts. A set of override settings can correspond to a part number that identifies a subset of systems on chip (e.g., a type of system on chip), a part number that corresponds to a serial number that uniquely identifies an individual system on chip (e.g., a specific system on chip), a part number that identifies a subset of microprocessors included in systems on chip (e.g., a type of microprocessor), a part number that corresponds to a serial number that uniquely identifies an individual microprocessor included in systems on chip (e.g., a specific microprocessor), combinations thereof, etc.

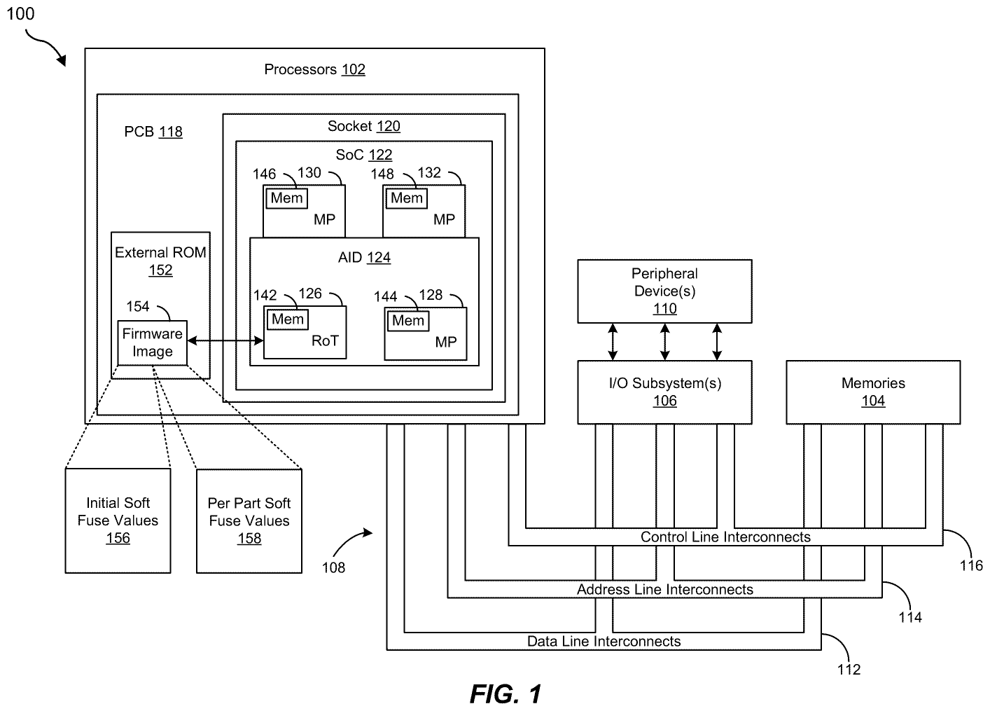

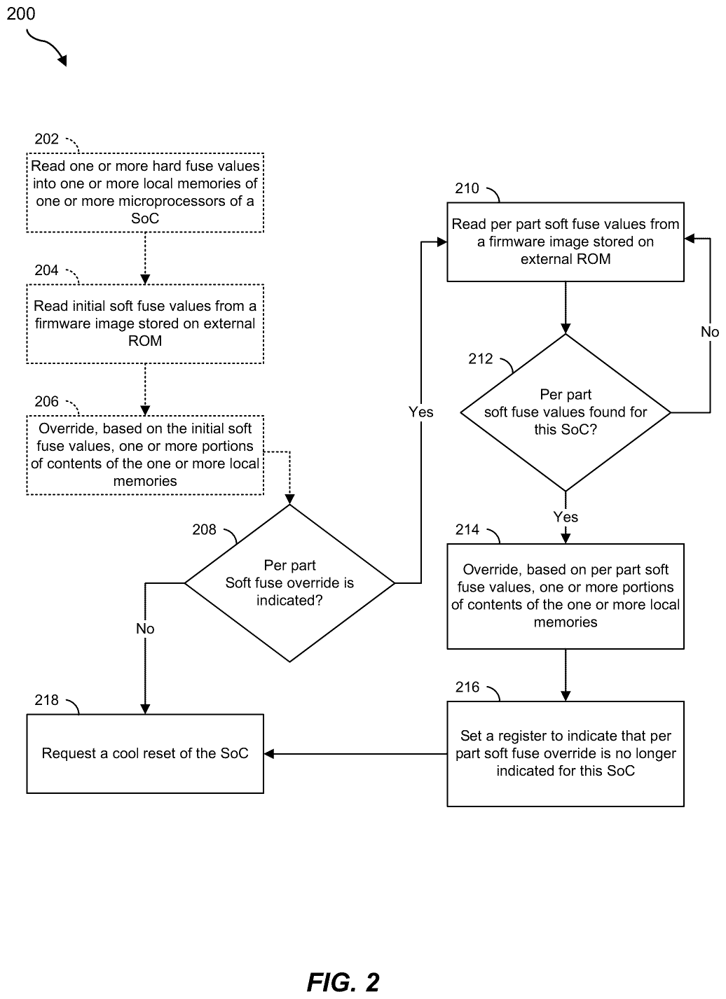

The following will provide, with reference to FIGS. 1, 3-5 and 8, detailed descriptions of example devices and systems for soft fuse override. Detailed descriptions of corresponding computer-implemented methods will also be provided in connection with FIGS. 2, 6, and 7.

In one example, a device can include a system on chip and a security processor of the system on chip that is configured to perform an override of one or more settings of the system on chip based on one or more settings of a setting record that correspond to a part number of the system on chip.

Another example can correspond to the previously described example device, wherein the security processor resides in an active interposer die of the system on chip and is configured to override one or more soft fuse settings of one or more microprocessors of the system on chip.

Another example can correspond to any of the previously described example devices, wherein the security processor corresponds to one of the one or more microprocessors and is configured to perform the override of the one or more soft fuse settings of at least one of the security processor, a first one of the one or more microprocessors that, along with the security processor, resides in the active interposer die, or a second one of the one or more microprocessors that resides in a chiplet stacked on the active interposer die.

Another example can correspond to any of the previously described example devices, further including an external read only memory storing a setting record.

Another example can correspond to any of the previously described example devices, further including a printed circuit board and a socket of the printed circuit board, wherein the system on chip resides in the socket and the external read only memory is attached to the printed circuit board at a location outside of the socket.

Another example can correspond to any of the previously described example devices, wherein the security processor is configured to read per part soft fuse settings from the external read only memory only if a setting of the system on chip indicates that the override is indicated for the system on chip.

Another example can correspond to any of the previously described example devices, wherein the security processor is configured to modify the setting upon performing the override to indicate that the override is no longer indicated.

Another example can correspond to any of the previously described example devices, wherein the setting record includes per part soft fuse settings and the security processor is configured to read the per part soft fuse settings until it finds one or more soft fuse settings corresponding to a serial number of the system on chip.

The device of claim 1, wherein the security processor is configured to override one or more soft fuse settings of one or more microprocessors of the system on chip based on addresses of data read, by the security processor, from the setting record.

In another example, a system can include a printed circuit board that includes a socket and that has an external read only memory attached thereto at a location outside of the socket, wherein the external read only memory stores per part soft fuse values and a system on chip residing in the socket, wherein the system on chip includes an active interposer die and a plurality of microprocessors that includes a security processor residing in the active interposer die, wherein the security processor is configured to perform an override of one or more soft fuse settings of the system on chip based on one or more of the per part soft fuse values that correspond to a part number of the system on chip.

Another example can correspond to the previously described example system, wherein the security processor is configured to read the per part soft fuse values from the external read only memory until it finds one or more soft fuse values corresponding to a serial number of the system on chip.

Another example can correspond to any of the previously described example systems, wherein the security processor is configured to perform the override of the one or more soft fuse settings of one or more microprocessors of the system on chip based on addresses of data read, by the security processor, from the external read only memory.

Another example can correspond to any of the previously described example systems, wherein the security processor is configured to read per part soft fuse values from the external read only memory only if a setting of the system on chip indicates that the override is indicated for the system on chip.

Another example can correspond to any of the previously described example systems, wherein the security processor is configured to modify the setting upon performing the override to indicate that the override is no longer indicated.

Another example can correspond to a method that includes overriding settings of an integrated circuit device by reading one or more settings from a setting record that correspond to a part number of the integrated circuit device and performing an override of the settings of the integrated circuit device based on the one or more settings of the setting record that correspond to the part number of the integrated circuit device.

Another example can correspond to the previously described example method, wherein the settings of the integrated circuit device that are being overridden comprise soft fuse override settings.

Another example can correspond to any of the previously described example methods, wherein reading the one or more settings includes reading per part soft fuse values from the setting record until finding one or more soft fuse values corresponding to a serial number of the integrated circuit device.

Another example can correspond to any of the previously described example methods, wherein using the one or more settings includes performing the override of the soft fuse override settings of one or more microprocessors of the integrated circuit device based on addresses of data read from the setting record.

Another example can correspond to any of the previously described example methods, wherein reading the one or more settings occurs only if a setting of the integrated circuit device indicates that the override is indicated for the integrated circuit device.

Another example can correspond to any of the previously described example methods, further including modifying the setting of the integrated circuit device coincident with performing the override to indicate that the override is no longer indicated.

FIG. 1 illustrates an example system 100 configured to perform soft fuse override. For example, system 100 can include one or more processors 102, one or more memories 104, and one or more input/output (I/O) subsystems 106 connected by a system bus 108. Processors 102 can include central processing units (CPUs) and/or co-processors, such as graphics processing units (GPUs), accelerator processing units (APUs), arithmetic logic units (ALUs), etc. Memories 104 can correspond to electronic holding places for the instructions and/or data that a computer needs to reach quickly, such as cache memory, main memory, and/or secondary memory. I/O subsystems 106 can correspond to devices that transfer data to and/or from a computer and control communication between processors 102 and peripheral devices 110. Peripheral devices 110 can correspond to devices that connect to a core computing unit, such as monitors, mice, keyboards, printers, external memory, etc. In turn, I/O subsystems 106 can include controllers for each of the peripheral devices 110. One or more processors 102, one or more memories 104, and one or more input/output (I/O) subsystems 106 can be implemented as one or more semiconductor device packages connected to one or more printed circuit boards. Some or all of processors 102, memories 104, I/O subsystems 106, system bus 108, and/or peripheral devices 110 can be implemented on a printed circuit board, such as a motherboard.

As shown in FIG. 1, a system bus 108 can be a communication system that transfers data between components inside a computer, or between computers. System bus 108 can include various interconnects, such as data line interconnects 112, address line interconnects 114, and control line interconnects 116. Data line interconnects 112, in the context of technology and computing, can refer to a communication path that facilitates the transmission of data between devices or systems. Address line interconnects 114 can refer to a physical connection between a CPU/chipset and memory and specify which address to access in the memory. Control line interconnects 116 can receive signals that manage varied chip operations (e.g., scan and write). One or more processors 102 can perform interposer seating indication as described herein.

As shown in FIG. 1, processors 102 can include a PCB 118 that includes a socket 120 receiving a semiconductor device package, such as a processor package, seated therein. The semiconductor device package can include a SoC 122 having an interconnect device 124 that can correspond to an AID. Interconnect device 124 can have multiple microprocessors, including a security processor 126 (e.g., ROT) inside the interconnect device 124, another microprocessor 128 inside the interconnect device 124, and other microprocessors 130 and 132 implemented in chiplets stacked on the interconnect device 124. Each microprocessor can include local memories 142, 144, 146, and 148.

Local memories 142-148 can be implemented in various ways. For example, local memories can correspond to random access memory (RAM), such as dynamic random access memory (DRAM) or static random access memory (SRAM). For example, a single piece of DRAM is composed of a large two-dimensional array of cells containing ones or zeros that are connected by bitlines and wordlines. Each individual cell can be accessed by utilizing the intersection of a specific wordline and bitline and reading from or storing to the cell at this address. Similarly, SRAM arrays are arranged in several rows and columns of storage bit-cells called bit-lines (BL and BL′) and word-lines (WL) to control data access and storage. The bit-cells are bi-stable flip-flops which comprise four to eleven transistors with pull-up (PU), pull-down (PD), and pass-gate (PG) networks. Alternatively, local memories can correspond to Worms, FLASH memory cells, etc.

As shown in FIG. 1, processors 102 can include an external read only memory (ROM) 152 (e.g., storing a firmware image 154). External read only memory 152 can be coupled to the PCB 118 that includes the socket 120. As part of a boot process, security processor 126 can access external read only memory 152, read chunks of the firmware image 154, and load the chunks into local memory 142 of the security processor. For example, local memory 142 can have a smaller memory capacity than external read only memory 152, and thus, can load one chunk of the firmware image at a time into local memory 142. Security processor 126 can, for example, read initial soft fuse values 156 and per part soft fuse values 158 from the firmware image 154 and process these values in various ways, an example of which is detailed below with reference to FIG. 2.

FIG. 2 illustrates one or more methods 200 of performing soft fuse override. Referring now to FIGS. 1 and 2, security processor 126 can, at step 202, begin a boot process by reading settings of hard fuses of the SoC 122 (e.g., of a package including SoC 122) and loading them into the local memories 142-148. In some implementations, security processor 126 can also transmit the settings of the hard fuses to other SoCs in socket 120. The security processor 126 can then perform a first stage of a soft fuse override process by reading, at step 204, initial soft fuse values 156 from the firmware image 154 and overriding, at step 206, (e.g., overwriting) one or more portions (e.g., one or more hard fuse settings) of contents of the local memories 142-148. In some implementations, security processor 126 can also transmit the initial soft fuse values to other SoCs in socket 120.

As shown in FIGS. 1 and 2, security processor 126 can additionally perform per part soft fuse override as a second stage of the soft fuse override process. For example, beginning at step 208, security processor 126 can read a setting of a register of the SoC 122, and based on the setting, determine if per part soft fuse override is indicated. In this context, the indication can signify that per part soft fuse override has not yet been performed for a part corresponding to the SoC or a part of the SoC, and/or that it is required, recommended, and/or available as an option. If security processor 126 determines, at step 208, that per part soft fuse override is indicated, then security processor 126 can, at step 210, read per part soft fuse values 158 stored in a setting record of firmware image 154 stored on the external read only memory 152. In this context, various types of setting records can include setting customization records, one or more files storing initial soft fuse values, one or more files storing per part soft fuse values, etc. The per part soft fuse values 158 stored in the firmware image 154 can include soft fuse values for numerous parts and, thus, be too large for security processor to load it into its local memory 142. Accordingly, security processor 126 can, at step 210, load one chunk of the per part soft fuse values 158 into the local memory 142 at a time and, at step 212, parse a header of the chunk to analyze a part number (e.g., serial number of SoC 122 and/or of a package including SoC 122) associated with soft fuse values included in the chunk in association with the header. For example, security processor can, at step 212, compare the serial number of the header to a serial number of the SoC and determine if there is a match. If security processor 126 determines, at step 212, that there is not a match, then processing can return to step 210, in which security processor 126 can read another chunk of the per part soft fuse values 158 and load it into the local memory 142 for further analysis at step 212.

As shown in FIGS. 1 and 2, when security processor 126 determines, at step 212, that there is a match, then security processor 126 can, at step 214, override (e.g., overwrite) one or more portions (e.g., one or more hard fuse settings and/or one or more initial soft fuse values) of contents of the local memories 142-148. For example, security processor 126 can, at step 214, perform the override of the one or more portions of contents of the local memories 142-148 based on addresses of data read from the setting record. In this context, the addresses can route various different portions of the per part soft fuse values to different ones of the local memories 142-148. In some implementations, security processor 126 can also transmit the per part soft fuse values to one or more other SoCs in socket 120, and these transmissions can also be routed to the other SoCs based on addresses associated with various different portions of the per part soft fuse values. In still other implementations, security processor 126 can further coordinate per part soft fuse override for one or more other SoCs in the socket 120 based on one or more serial numbers of the one or more other SoCs and one or more additional register settings indicating whether per part soft fuse override is indicated for the one or more other SoCs.

As shown in FIGS. 1 and 2, coincident with performance of the override at step 214, security processor 126 can, as step 216, modify a setting (e.g., a setting of a register of SoC 122) to indicate that per part soft fuse override is no longer indicated for SoC 122. For example, security processor 126 can perform step 216 before, after, or in parallel with step 214. In some implementations, security processor 126 can also modify one or more settings to indicate that per part soft fuse override is no longer indicated for one or more other SoCs in socket 120.

As shown in FIGS. 1 and 2, security processor 126 can, at step 218, request a cool reset of the SoC 122. The cool reset can cause the SoC 122 to operate with functionality enabled and/or modified by the per part soft fuse values stored in the local memories 142-148. These per part soft fuse values can be preserved in the local memories 142-148, for example, due to the local memories corresponding to SRAMs, WORMS, or any other type of memory that persistently stores data. Hence, in subsequent boot procedures, security processor 126 can, at step 208, read the modified setting (e.g., as modified at step 216) of the register of the SoC 122, and based on the setting, determine that per part soft fuse override is not indicated for SoC 122. In this event, security processor 126 can proceed directly from step 208 to step 218.

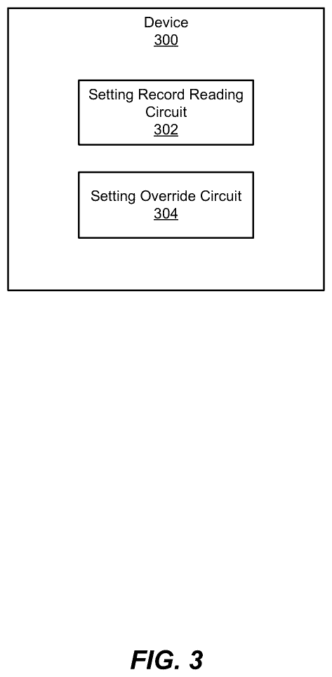

FIG. 3 is a block diagram of an example device 300 for performing soft fuse override functions, according to one or more implementations of the present disclosure. As shown, device 300 includes a setting record reading circuit 302 for reading settings for specific parts of an integrated circuit device. Device 300 can also include a setting override circuit 304 for overriding existing settings for the specific parts of the integrated circuit device. Examples of device 300 and circuits 302 and 304 include, without limitation, micro-processors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

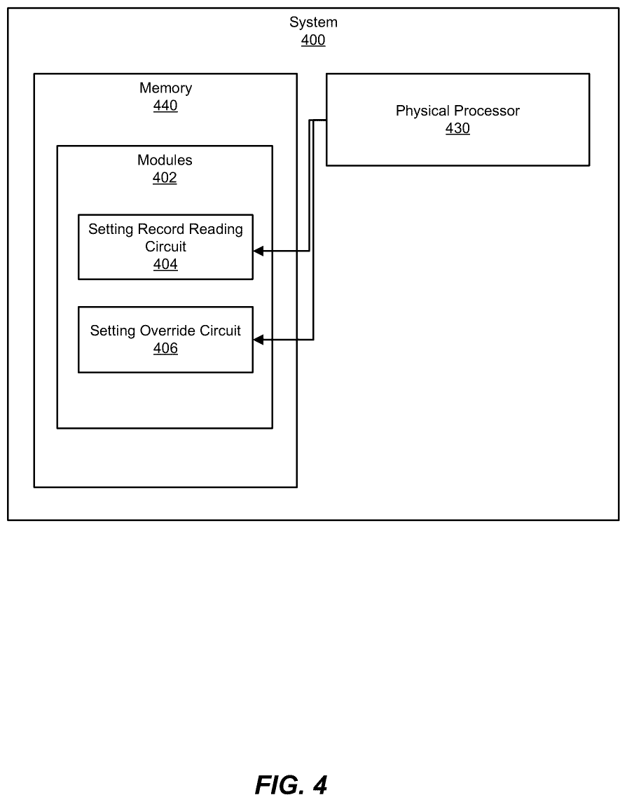

Reading a setting record and overriding settings can be performed by any suitable combination of physical hardware, firmware, and/or software and can be implemented in any suitable type or form of computing system. For example, FIG. 4 is a block diagram of an example system 400 for soft fuse override. As illustrated in this figure, example system 400 can include one or more modules 402 for performing one or more tasks. As will be explained in greater detail below, modules 402 can include a setting record reading circuit 404 and a setting override circuit 406. Although illustrated as separate elements, one or more of modules 402 in FIG. 4 can represent portions of a single module or application.

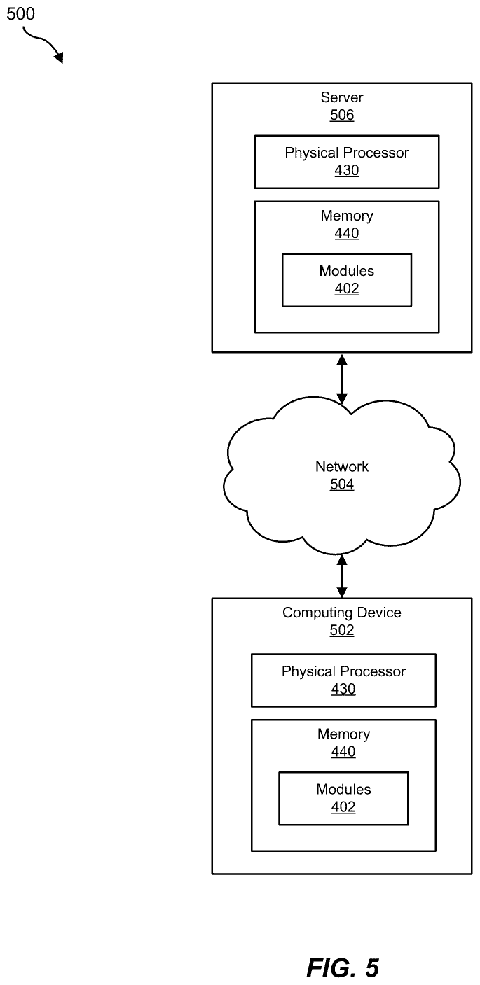

In certain implementations, one or more of modules 402 in FIG. 4 can represent one or more software applications or programs that, when executed by a computing device, can cause the computing device to perform one or more tasks. For example, and as will be described in greater detail below, one or more of modules 402 can represent modules stored and configured to run on one or more computing devices, such as the devices illustrated in FIG. 5 (e.g., computing device 502 and/or server 506). One or more of modules 402 in FIG. 4 can also represent all or portions of one or more special-purpose computers configured to perform one or more tasks.

As illustrated in FIG. 4, example system 400 can also include one or more memory devices, such as memory 440. Memory 440 generally represents any type or form of volatile or non-volatile storage device or medium capable of storing data and/or computer-readable instructions. In one example, memory 440 can store, load, and/or maintain one or more of modules 402. Examples of memory 440 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 4, example system 400 can also include one or more physical processors, such as physical processor 430. Physical processor 430 generally represents any type or form of hardware-implemented processing unit capable of interpreting and/or executing computer-readable instructions. In one example, physical processor 430 can access and/or modify one or more of modules 402 stored in memory 440. Additionally or alternatively, physical processor 430 can execute one or more of modules 402 to facilitate soft fuse override. Examples of physical processor 430 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Example system 400 in FIG. 4 can be implemented in a variety of ways. For example, all or a portion of example system 400 can represent portions of example system 500 in FIG. 5. As shown in FIG. 5, system 500 can include a computing device 502 in communication with a server 506 via a network 504. In one example, all or a portion of the functionality of modules 402 can be performed by computing device 502, server 506, and/or any other suitable computing system. As will be described in greater detail below, one or more of modules 402 from FIG. 4 can, when executed by at least one processor of computing device 502 and/or server 506, enable computing device 502 and/or server 506 to execute soft fuse override functions.

Computing device 502 generally represents any type or form of computing device capable of reading computer-executable instructions. Additional examples of computing device 502 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 506 generally represents any type or form of computing device that is capable of performing soft fuse override functions. Additional examples of server 506 include, without limitation, storage servers, database servers, application servers, and/or web servers configured to run certain software applications and/or provide various storage, database, and/or web services. Although illustrated as a single entity in FIG. 5, server 506 can include and/or represent a plurality of servers that work and/or operate in conjunction with one another.

Network 504 generally represents any medium or architecture capable of facilitating communication or data transfer. In one example, network 504 can facilitate communication between computing device 502 and server 506. In this example, network 504 can facilitate communication or data transfer using wireless and/or wired connections. Examples of network 504 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 400 in FIG. 4 and/or system 500 in FIG. 5. Conversely, all of the components and devices illustrated in FIGS. 4 and 5 need not be present to practice the implementations described and/or illustrated herein. The devices and subsystems referenced above can also be interconnected in different ways from that shown in FIG. 5. Systems 400 and 500 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, can generally refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

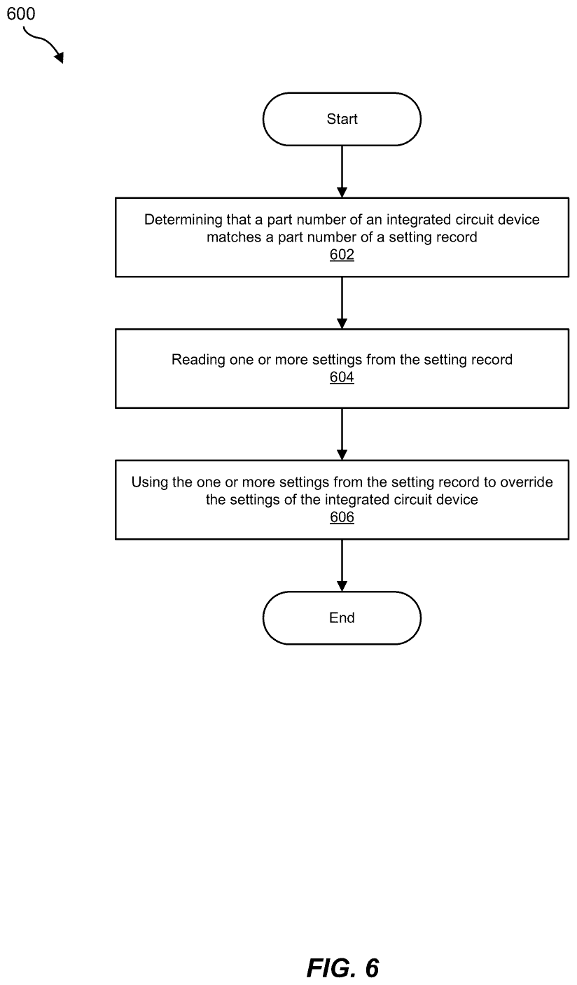

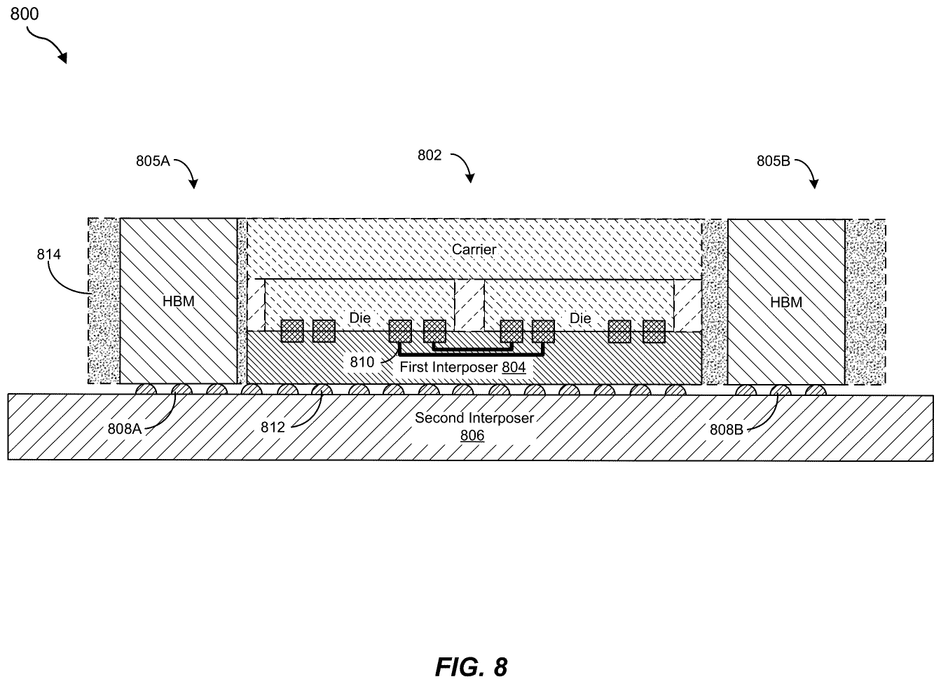

FIG. 6 is a flow diagram of an example computer-implemented method 600 for soft fuse override. The steps shown in FIG. 6 can be performed by any suitable computer-executable code and/or computing system, including device 300 in FIG. 3, system 400 in FIG. 4, system 500 in FIG. 5, package 800 in FIG. 8, and/or variations or combinations of one or more of the same. In one example, each of the steps shown in FIG. 6 can represent an algorithm whose structure includes and/or is represented by multiple sub-steps, examples of which will be provided in greater detail below.

As illustrated in FIG. 6, at step 602 one or more of the systems described herein can determine that a part number of an integrated circuit device matches a part number of a setting record.

At step 604, one or more of the systems described herein can read one or more settings from the setting record.

At step 606, one or more of the systems described herein can use the one or more settings from the setting record to override the settings of the integrated circuit device.

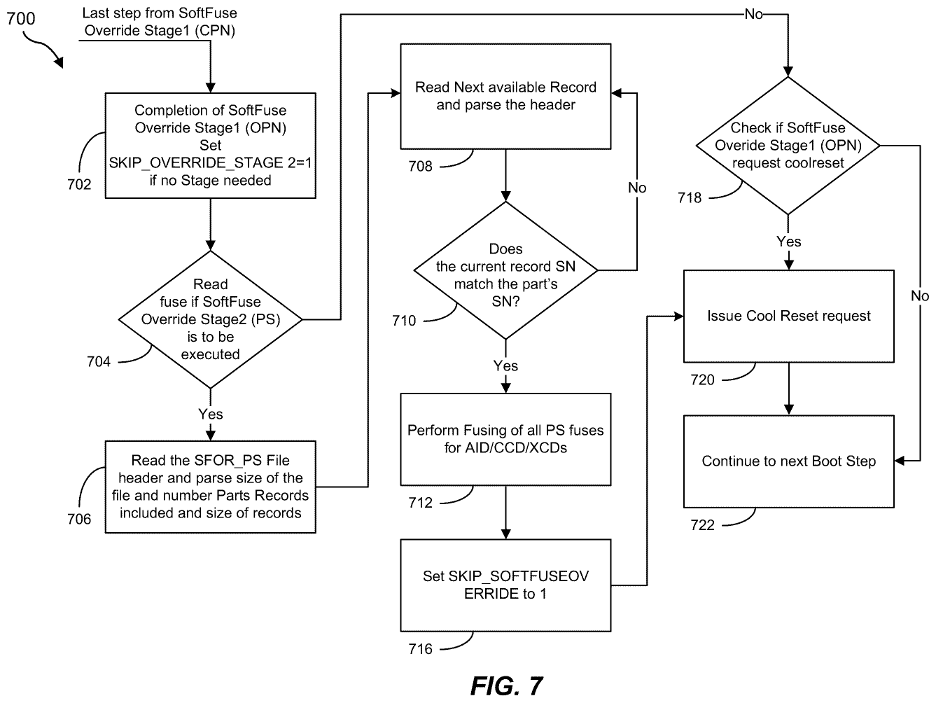

FIG. 7 is a flow diagram of an example method 700 for soft fuse override, according to one or more additional implementations of the present disclosure. In FIG. 7, Stage 1 refers to the application of generic settings for parts of a system or device, and Stage 2 refers to the application of customized settings for the parts of the system or device. Method 700 starts, at step 702, at the point of completion of Stage 1, namely applying generic settings to the parts. If, at step 702, Stage 2 is to be executed, such as in response to a customer request that part-specific settings be updated, a setting record (e.g., a set of soft fuse override part settings (SFOR_PS)) can be used to override and update the part settings as desired, as illustrated in FIG. 7. For example, if, at steps 706, 708, and 710, the setting record includes a part number (e.g., serial number (SN)) indicated in the setting record as requiring an updated setting, all part setting fuses for the identified part can be updated at step 712. Such identified parts can include, without limitation, an active interposer die (AID in FIG. 7 and in some implementations one or more of first interposer 804 and/or second interposer 806), a computer processor (CCD in FIG. 7 and in some implementations, one or more dies of stacked dies 805A, 805B, and/or 802), and/or an additional processor (XCD in FIG. 7 and in some implementations, one or more dies of stacked dies 805A, 805B, and/or 802). After the fusing of the identified part settings is performed at step 712 and a setting is modified, at step 716 to indicate that the override is no longer indicated, a cool reset request can be issued at step 720, and the method 700 can proceed by continuing to a next boot step at step 722.

If register setting selects stage 2 execution at step 704, then a file associated

with stage 2 execution is read from read-only memory (ROM) in chunks at step 706. The file can include overrides for each microprocessor serial number arranged in sequence. In some embodiments, the file is larger than 64K, and hence reading and parsing by chunks can be necessary. A first read at step 706 can parse the file header, which can provide length of the file and the number of records corresponding to number of part entries. In addition, it can provide size of the records since all the records are of the same size. Following step 706, readout of records can commence at step 708 in a serial fashion until the serial number in the record header is found at step 710. When the record is found at step 710, each section for each interposer, processing unit, and/or accelerator can be parsed and overrides can be applied, at step 712 to appropriate rows based on the row addresses. Upon completion of the operation at step 712, a skip override fuse can be set, at step 716, to avoid repeating operation after cool reset, and cool reset can be requested at step 720 by triggering a general purpose input/output operation. Thereafter, Stage 2 can be skipped at step 704 and cool reset can be requested at step 720 based on a request, at step 718, for cool reset by Stage 1.

FIG. 8 illustrates an example package 800, corresponding to system 100 and/or system 400, for implementing any of the systems and methods described herein. Package 800 has a two-stack interposer and can include a plurality of stacked circuit dies 802 (e.g., 3D chiplet stacks) connected to a first interposer 804 (e.g., an active interposer die such as described herein). The term “circuit die,” as used herein, can generally refer to a small block of semiconducting material on which a given functional circuit is fabricated (e.g., a memory unit, logic unit, etc.). For example, and without limitation, integrated circuits can be produced in large batches on a single wafer of electronic-grade silicon (EGS) or other semiconductor through processes such as photolithography. The term “stacked,” as used herein, can generally refer to 3D packaging. For example, and without limitation, stacked circuit dies can be configured according to 3D integration schemes that rely on traditional interconnection methods such as wire bonding and flip chip to achieve vertical stacking. Example types of 3D packages can include 3D system in package (3D SiP) and 3D wafer level package (3D WLP). Although FIG. 8 illustrates a single die tier for stacked circuit dies 802, other implementations can include additional die tiers. The term “interposer,” as used herein, can generally refer to an electrical interface routing between one socket or connection to another. For example, and without limitation, an interposer can spread a connection to a wider pitch or reroute a connection to a different connection. Types of interposers can include silicon interposers, silicon interposers that use system on integrated chip_horizontal (SolC_H) technology, organic interposers, and glass interposers. Unlike organic interposers and glass interposers, silicon interposers are composed of SiO2 or polymers and have a relatively higher cost (e.g., three times higher per wafer).

In some implementations, package 800 can additionally include a second interposer 806 connected to the first interposer 804. In some examples, package 800 can also include an additional plurality of stacked circuit dies 805A and 805B connected to the second interposer 806, although in other implementations other connections can be used. Moreover, each of stacked circuit dies 805A and/or 805B can include one or more die tiers.

Parts of package 800 can be connected in various ways. For example, the additional plurality of stacked circuit dies 805A and 805B can be connected to the second interposer 806 by one or more solder interconnects 808A and 808B. Additionally in some examples, first interposer 804 can be connected to the plurality of stacked circuit dies 802 by hybrid bonding. The term “hybrid bonding,” as used herein, can generally refer to forming a permanent bond that combines a dielectric bond with embedded metal (e.g., copper) to form interconnections. For example, and without limitation, hybrid bonding can allow for face-to-face connection of wafers or dies and provide both mechanical support and dense electrical interconnects. In some examples, hybrid bonding can be used for advanced 3D device stacking and heterogeneous integration applications. Hybrid bonding can deliver up to one-thousand times more connections than copper microbumps and reduce signal delay. Also, second interposer 806 can be connected to first interposer 804 by one or more solder interconnects 812.

The term “solder interconnects,” as used herein, can generally refer to electrical connections made using a fusible metal alloy to create a permanent bond between metal workpieces. For example, and without limitation, solder interconnects can be made with solder bumps that are small spheres of solder (e.g., solder balls) that are bonded to contact areas or pads of semiconductor devices. Solder bumps can be used for face-down bonding.

Parts of package 800 can vary in numerous ways. For example, the additional plurality of stacked circuit dies 805A and 805B can correspond to at least one high bandwidth memory (HBM) stack. The term “high bandwidth memory,” as used herein, can generally refer to a high-speed computer memory interface for 3D-stacked synchronous dynamic random-access memory (SDRAM). For example, and without limitation, high bandwidth memory can be used in conjunction with high-performance graphics accelerators, network devices, high-performance datacenter AI ASICs and FPGAs, and in some supercomputers. Additionally, first interposer 804 can correspond to a silicon interposer (e.g., an SolC_H interposer). Also, second interposer 806 can be made of organic material and/or glass and in some examples may correspond to a substrate such as a printed circuit board (PCB).

In some implementations, data communication between different stacks of circuit dies of plurality of stacked circuit dies 802 can be handled by first interposer 804, such as through one or more interconnect 810 (corresponding to conductive elements such as wiring, through-silicon vias (TSV), etc.) in first interposer 804. In some examples, data communication between different stacked circuit dies 802 can be handled exclusively by first interposer 804. In some examples, data communication between circuit dies of a same stack of circuit dies 802 can be handled though interconnects therebetween (e.g., TSVs, and other conductive elements, not shown in FIG. 8). In addition, data communication between the plurality of stacked circuit dies 802 and the additional plurality of stacked circuit dies 805A and 805B can be handled by first interposer 804 and second interposer 806 in combination and/or individually.

Package 800 can have additional parts. For example, package 800 can include mold material 814 (e.g., non-dielectric epoxy) provided between and/or beside the plurality of stacked circuit dies 802 and additional stacked circuit dies 804A and/or 804B. Additionally, massively parallel chips (e.g., stacked circuit dies 802) can include tiered circuit dies and/or wafers arranged beneath a top carrier with gap filler (e.g., dielectric epoxy) provided between and/or beside the tiered circuit dies.

By way of example, package 800 can include and/or otherwise correspond to the parts identifiable by the setting records as described herein. For example, first interposer 804 and/or second interposer 806 can correspond to the AIDs described herein, and the HBMs of stacked dies 805A and/or 805B can correspond to the memory devices described herein and dies of stacked dies 802 can correspond to the processors and/or other components described herein.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 400 in FIG. 4 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 400 in FIG. 4 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 400 in FIG. 4 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of example system 400 in FIG. 4 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a system on chip; and
a security processor of the system on chip that is configured to perform an override of one or more settings of the system on chip based on one or more settings of a setting record that correspond to a part number of the system on chip.

2. The device of claim 1, wherein the security processor resides in an active interposer die of the system on chip and is configured to override one or more soft fuse settings of one or more microprocessors of the system on chip.

3. The device of claim 2, wherein the security processor corresponds to one of the one or more microprocessors and is configured to perform the override of the one or more soft fuse settings of at least one of:
the security processor;
a first one of the one or more microprocessors that, along with the security processor, resides in the active interposer die; or
a second one of the one or more microprocessors that resides in a chiplet stacked on the active interposer die.

4. The device of claim 1, further comprising:
an external read only memory storing the setting record.

5. The device of claim 4, further comprising:
a printed circuit board; and
a socket of the printed circuit board, wherein the system on chip resides in the socket and the external read only memory is attached to the printed circuit board at a location outside of the socket.

6. The device of claim 4, wherein the security processor is configured to read per part soft fuse settings from the external read only memory only if a setting of the system on chip indicates that the override is indicated for the system on chip.

7. The device of claim 6, wherein the security processor is configured to modify the setting upon performing the override to indicate that the override is no longer indicated.

8. The device of claim 1, wherein the setting record includes per part soft fuse settings and the security processor is configured to read per part soft fuse settings until it finds one or more soft fuse settings corresponding to a serial number of the system on chip.

9. The device of claim 1, wherein the security processor is configured to override one or more soft fuse settings of one or more microprocessors of the system on chip based on addresses of data read, by the security processor, from the setting record.

10. A system, comprising:
a printed circuit board that includes a socket and that has an external read only memory attached thereto at a location outside of the socket, wherein the external read only memory stores per part soft fuse values; and
a system on chip residing in the socket, wherein the system on chip includes an active interposer die and a plurality of microprocessors that includes a security processor residing in the active interposer die,
wherein the security processor is configured to perform an override of one or more soft fuse settings of the system on chip based on one or more of the per part soft fuse values that correspond to a part number of the system on chip.

11. The system of claim 10, wherein the security processor is configured to read the per part soft fuse values from the external read only memory until it finds one or more soft fuse values corresponding to a serial number of the system on chip.

12. The system of claim 10, wherein the security processor is configured to perform the override of the one or more soft fuse settings of one or more microprocessors of the system on chip based on addresses of data read, by the security processor, from the external read only memory.

13. The system of claim 10, wherein the security processor is configured to read per part soft fuse values from the external read only memory only if a setting of the system on chip indicates that the override is indicated for the system on chip.

14. The system of claim 13, wherein the security processor is configured to modify the setting upon performing the override to indicate that the override is no longer indicated.

15. A method comprising:
overriding settings of an integrated circuit device by:
reading one or more settings from a setting record that correspond to a part number of the integrated circuit device; and
performing an override of the settings of the integrated circuit device based on the one or more settings of the setting record that correspond to the part number of the integrated circuit device.

16. The method of claim 15, wherein the settings of the integrated circuit device that are being overridden comprise soft fuse override settings.

17. The method of claim 16, wherein reading the one or more settings includes reading per part soft fuse values from the setting record until finding one or more soft fuse values corresponding to a serial number of the integrated circuit device.

18. The method of claim 16, wherein using the one or more settings includes performing the override of the soft fuse override settings of one or more microprocessors of the integrated circuit device based on addresses of data read from the setting record.

19. The method of claim 15, wherein reading the one or more settings occurs only if a setting of the integrated circuit device indicates that the override is indicated for the integrated circuit device.

20. The method of claim 19, further comprising:
modifying the setting of the integrated circuit device coincident with performing the override to indicate that the override is no longer indicated.
